(19) United States
(12) Patent Application Publication
(10) Pub. No.: US 2022/0136143 A1
(43) Pub. Date: May 5, 2022

(54) HYDROPHILIC FABRIC AND MANUFACTURING METHOD THEREOF

(71) Applicant: NanoTubeTec Co., LTD, Hsinchu City (TW)

(72) Inventor: Ted Hong Shinn, Hsinchu City (TW)

(73) Assignee: NanoTubeTec Co., LTD, Hsinchu City (TW)

(21) Appl. No.: 17/084,667

(22) Filed: Oct. 30, 2020

(51) Int. Cl. D03D 15/00; D01F 9/12; D01F 8/18; C01B 32/168

(52) U.S. Cl. CPC D03D 15/0094; D01F 9/12; D01F 8/18; C01B 32/168; D03D 2700/0148; B82Y 30/00; D10B 2501/04; C01P 2002/54; C01B 2202/36; C01P 2006/10; D10B 2401/022

(57) ABSTRACT

Provided are a hydrophilic fabric and a manufacturing method thereof. The hydrophilic fabric has a structure in which warp yarns and weft yarns are interwoven with each other, wherein at least one of the warp yarns and the weft yarns includes carbon nanotube fibers, the carbon nanotube fibers contain N-doped carbon nanotubes, the nitrogen content in each of the N-doped carbon nanotubes is between 1 at. % and 10 at. %, and the content of the N-doped carbon nanotubes in the hydrophilic fabric is at least 1 wt. % based on the total weight of the hydrophilic fabric.

### BACKGROUND

### Technical Field

The present invention relates to a fabric and a manufacturing method thereof, and particularly relates to a hydrophilic fabric and a manufacturing method thereof.

### Description of Related Art

In today's textile industry, fabrics with various functions have been widely used. By interweaving different types of fibers to form a fabric, the fabric can have different functions. For example, fibers with hydrophilicity and high abrasion resistance may be used in functional clothing. Therefore, how to improve the above-mentioned characteristics of the fabric has become one of the urgent research topics in the industry.

### SUMMARY

The present invention provides a hydrophilic fabric, which is woven from carbon nanotube fibers containing nitrogen-doped (N-doped) carbon nanotubes.

The present invention provides a manufacturing method of a hydrophilic fabric, in which carbon nanotube fibers containing N-doped carbon nanotubes are used for weaving.

A hydrophilic fabric of the present invention has a structure in which warp yarns and weft yarns are interwoven with each other, wherein at least one of the warp yarns and the weft yarns includes carbon nanotube fibers, the carbon nanotube fibers contain N-doped carbon nanotubes, the nitrogen content in each of the N-doped carbon nanotubes is between 1 at. % and 10 at. %, and the content of the N-doped carbon nanotubes in the hydrophilic fabric is at least 1 wt. % based on the total weight of the hydrophilic fabric.

In an embodiment of the hydrophilic fabric of the present invention, the carbon nanotube fibers contain natural fiber material.

In an embodiment of the hydrophilic fabric of the present invention, the natural fiber material includes cotton, linen, wool, rabbit hair, silk, tencel or coffee.

In an embodiment of the hydrophilic fabric of the present invention, the diameter of the carbon nanotube fibers is between 10 nm and 100 nm.

In an embodiment of the hydrophilic fabric of the present invention, the density of the carbon nanotube fibers is between 0.5 g/cm³ and 1.8 g/cm³.

In an embodiment of the hydrophilic fabric of the present invention, the material of the weft yarns is the same as the material of the warp yarns.

In an embodiment of the hydrophilic fabric of the present invention, the material of the weft yarns is different from the material of the warp yarns.

In an embodiment of the hydrophilic fabric of the present invention, one of the warp yarns and the weft yarns includes carbon nanotube fibers, and the other of the warp yarns and the weft yarns includes cotton fiber yarn, linen fiber yarn, wool fiber yarn, rabbit hair fiber yarn, silk fiber yarn, tencel fiber yarn, coffee fiber Yarn, nylon fiber yarn, polyester fiber yarn, rayon fiber yarn, acrylic fiber yarn or polyurethane fiber yarn.

In an embodiment of the hydrophilic fabric of the present invention, the diameter of the fiber constituting the other of the warp yarns and the weft yarns is between 10 nm and 10⁶ nm.

In an embodiment of the hydrophilic fabric of the present invention, the diameter of the fiber constituting the other of the warp yarns and the weft yarns is between 10 nm and 10⁶ nm.

In an embodiment of the hydrophilic fabric of the present invention, the contact angle of the hydrophilic fabric is between 40° and 70°.

A manufacturing method of a hydrophilic fabric of the present invention includes the following steps. N-doped carbon nanotubes are grown on a substrate, wherein the nitrogen content in each of the N-doped carbon nanotubes is between 1 at. % and 10 at. %. A drawing processing is performed on the N-doped carbon nanotubes to form carbon nanotube fibers. A spinning processing is performed on the carbon nanotube fibers to form carbon nanotube fiber yarns. A weaving process is performed on the carbon nanotube fiber yarns. The content of N-doped carbon nanotubes in the hydrophilic fabric is at least 1 wt. % based on the total weight of the hydrophilic fabric.

In an embodiment of the manufacturing method of the present invention, the carbon nanotubes is further mixed with natural fiber material after forming the carbon nanotubes but before the drawing process.

In an embodiment of the manufacturing method of the present invention, the natural fiber material includes cotton, linen, wool, rabbit hair, silk, tencel or coffee.

In an embodiment of the manufacturing method of the present invention, the diameter of the carbon nanotube fibers is between 10 nm and 100 nm.

In an embodiment of the manufacturing method of the present invention, the density of the carbon nanotube fibers is between 0.5 g/cm³ and 1.8 g/cm³.

In an embodiment of the manufacturing method of the present invention, the carbon nanotube fiber yarns are used as one of the warp yarns and the weft yarns, and the material of the weft yarns is different from the material of the warp yarns during the weaving process.

In an embodiment of the manufacturing method of the present invention, one of the warp yarns and the weft yarns includes carbon nanotube fibers, and the other of the warp yarns and the weft yarns includes cotton fiber yarn, linen fiber yarn, wool fiber yarn, rabbit hair fiber yarn, silk fiber yarn, tencel fiber yarn, coffee fiber yarn, nylon fiber yarn, polyester fiber yarn, rayon fiber yarn, acrylic fiber yarn or polyurethane fiber yarn.

In an embodiment of the manufacturing method of the present invention, the diameter of the fiber constituting the other of the warp yarns and the weft yarns is between 10 nm and 10⁶ nm.

In an embodiment of the manufacturing method of the present invention, the material of the weft yarns is the same as the material of the warp yarns.

In an embodiment of the manufacturing method of the present invention, the contact angle of the hydrophilic fabric is between 40° and 70°.

Based on the above, in the hydrophilic fabric of the present invention, yarns containing N-doped carbon nanotubes with the nitrogen content between 1 at. % and 10 at. % are used as warp yarns and/or weft yarns, and the content of the N-doped carbon nanotubes in the hydrophilic fabric is at least 1 wt. % based on the total weight of the hydrophilic fabric. Therefore, the hydrophilic fabric of the present invention may have excellent hydrophilicity, and have good mechanical strength, stain resistance and ductility at the same time.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a manufacturing flow chart of a hydrophilic fabric according to an embodiment of the present invention.

FIG. 2 is a schematic top view of a hydrophilic fabric according to an embodiment of the present invention.

FIG. 3 is a schematic top view of a hydrophilic fabric according to another embodiment of the present invention.

### DESCRIPTION OF THE EMBODIMENTS

The embodiments are described in detail below with reference to the accompanying drawings, but the embodiments are not intended to limit the scope of the present invention. In addition, the drawings are for illustrative purposes only and are not drawn to the original dimensions. For the sake of easy understanding, the same elements in the following description will be denoted by the same reference numerals.

In addition, the terms mentioned in the text, such as “comprising”, “including”, “containing” and “having” are all open-ended terms, i.e., meaning “including but not limited to”.

In the present invention, yarns containing N-doped carbon nanotubes with the nitrogen content between 1 at. % and 10 at. % are used as warp yarns and/or weft yarns and woven to form a fabric. Further, in the fabric, the content of N-doped carbon nanotubes is at least 1 wt. % based on the total weight of the fabric. Therefore, the formed fabric may have an excellent hydrophilicity, and have good mechanical strength, stain resistance and ductility depending on the characteristics of the carbon nanotubes at the same time. The hydrophilic fabric of the present invention and the manufacturing method thereof will be described below.

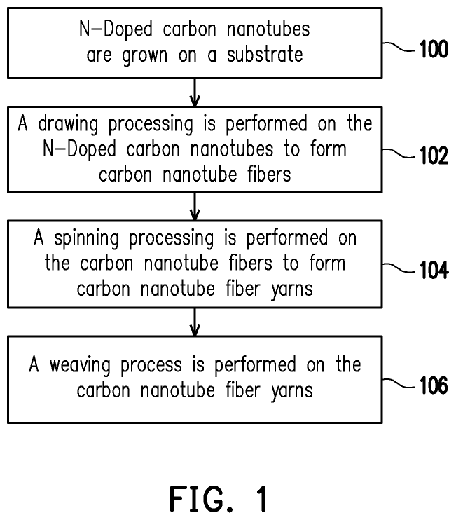

FIG. 1 is a manufacturing flow chart of a hydrophilic fabric according to an embodiment of the present invention. Referring to FIG. 1, in step 100, N-doped carbon nanotubes are grown on a substrate. The substrate may be a silicon oxide substrate. The method of growing N-doped carbon nanotubes is, for example, a chemical vapor deposition (CVD) process and an N-doping treatment performed in-situ. In the present embodiment, the nitrogen content in each of the formed carbon nanotubes is between 1 at. % and 10 at. %. During the growth of carbon nanotubes, the parameters of the deposition process may be adjusted to obtain carbon nanotubes with the required diameter and the required growth density. In addition, before performing the deposition process, a layer of metal particles may be formed on the substrate as a catalytic layer. The material of the metal particles is, for example, iron, nickel, cobalt, aluminum or a combination thereof. By controlling the distribution of metal particles, the physical properties such as the diameter and growth density of the formed carbon nanotubes may be further adjusted.

Then, in step 102, a drawing process is performed on the formed carbon nanotubes to form carbon nanotube fibers. Therefore, in the present embodiment, the nitrogen content in each of the formed carbon nanotube fibers is between 1 at. % and 10 at. %. The steps of the drawing process includes, for example, using a tape to stick a corner of the substrate on which carbon nanotubes are formed and pulling it out in a direction perpendicular to the growth direction of the carbon nanotubes. At this time, the carbon nanotubes on the substrate are arranged in a filamentary manner due to Van Der Waal force, forming carbon nanotube fibers.

In the present embodiment, the nitrogen content in each of the carbon nanotubes is between 1 at. % and 10 at. %. When the nitrogen content is less than 1 at. %, the formed carbon nanotube fibers cannot have sufficient hydrophilicity. When the nitrogen content is higher than 10 at. %, the carbon nanotubes cannot be grown due to nitrogen defectives.

In addition, in step 102, depending on actual needs, carbon nanotubes may be optionally pre-mixed with natural fiber materials, and then subjected to the drawing process. In this way, carbon nanotube fibers with natural fiber characteristics may be formed. The natural fiber material may be cotton, linen, wool, rabbit hair, silk, tencel or coffee. For example, when carbon nanotubes are mixed with cotton, the carbon nanotube fibers formed by the drawing process may have both the characteristics of carbon nanotubes and the characteristics of cotton. The diameter of the formed carbon nanotube fibers is, for example, between 10 nm and 100 nm. In addition, depending on the growth density of carbon nanotubes, the density of the formed carbon nanotube fibers is, for example, between 0.5 g/cm³ and 1.8 g/cm³.

Next, in step 104, the formed carbon nanotube fibers are subjected to a spinning process to form carbon nanotube fiber yarns. At this time, the carbon nanotube fiber yarns may have various required characteristics depending on the components in the previously formed carbon nanotube fibers, which is not limited in the present invention. The spinning process is well known to those skilled in the art, and will not be further described here. In addition, the formed carbon nanotube fiber yarns have a required diameter depending on the actual situation, which is not limited in the present invention. In the above-mentioned spinning process, the formed carbon nanotube fiber may also be mixed with other fibers to form a carbon nanotube fiber yarn.

After that, in step 106, the formed carbon nanotube fiber yarns are woven to form a fabric. In the fabric of the present embodiment, the content of the N-doped carbon nanotubes must be at least 1 wt. % based on the total weight of the fabric. In this way, the fabric of the present embodiment may have sufficient hydrophilicity to serve as a hydrophilic fabric. When the content of the N-doped carbon nanotubes is less than 1 wt. %, the formed fabric cannot have sufficient hydrophilicity and cannot be used as a hydrophilic fabric.

Depending on actual needs, only the carbon nanotube fiber yarns containing the N-doped carbon nanotubes may be used to manufacture the hydrophilic fabric of the present invention. Alternatively, the carbon nanotube fiber yarns containing the N-doped carbon nanotubes and any existing yarns may be used together to manufacture the hydrophilic fabric of the present invention. This will be described below.

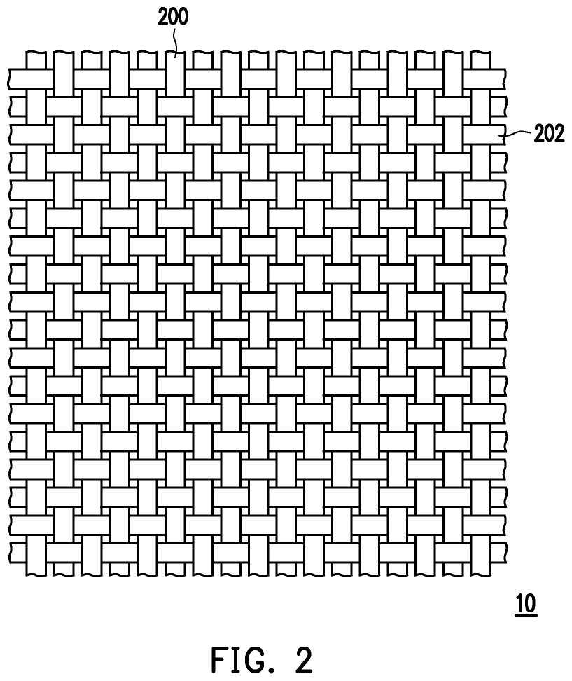

In the case of using only the carbon nanotube fiber yarns containing the N-doped carbon nanotubes to manufacture a hydrophilic fabric of the present invention, the carbon nanotube fiber yarns containing the N-doped carbon nanotubes are used as warp yarns and weft yarns and a weaving process is performed, such that warp yarns and weft yarns are interwoven to form a fabric, and the content of the N-doped carbon nanotubes in the fabric must be at least 1 wt. % based on the total weight of the fabric. In other words, the material of warp yarns is the same as that of weft yarns, and the total content of the N-doped carbon nanotubes in the warp yarns and weft yarns is at least 1 wt. %. As shown in FIG. 2, the carbon nanotube fiber yarns containing the N-doped carbon nanotubes are used as warp yarns 200 and weft yarns 202, respectively, the warp yarns 200 and weft yarns 202 are interwoven to form a hydrophilic fabric 10, and the total content of the N-doped carbon nanotubes in the warp yarns 200 and weft yarns 202 is at least 1 wt. %. However, the present invention does not limit the content of the N-doped carbon nanotubes in the warp yarns 200 and the weft yarns 202, respectively. Depending on the actual application, the hydrophilic fabric 10 may have various weaving densities, which is not limited in the present invention.

Since the entire of the hydrophilic fabric 10 is woven by using the carbon nanotube fiber yarns containing the N-doped carbon nanotubes, the hydrophilic fabric 10 has the same characteristics as the carbon nanotube fiber yarns. For example, depending on the characteristics of the carbon nanotube fiber yarns itself, the hydrophilic fabric 10 made of only the carbon nanotube fiber yarns containing the N-doped carbon nanotubes may have good mechanical strength, stain resistance and ductility. In addition, since carbon nanotubes are artificially synthesized material, they have lower microbial adhesion and inertness compared with natural material. Therefore, the toxin content in hydrophilic fabric 10 may be lower than that of natural material, and the hydrophilic fabric 10 is not easy to react with external substances and cause deterioration.

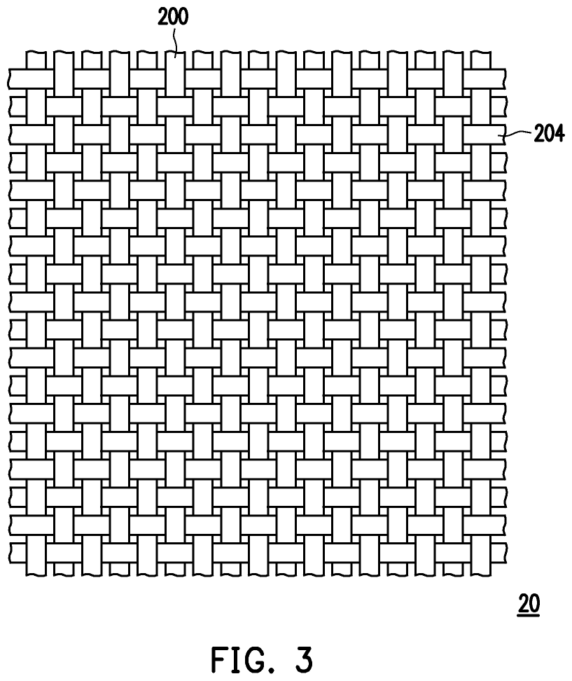

In the case of using the carbon nanotube fiber yarns containing the N-doped carbon nanotubes and any existing yarns to manufacture a hydrophilic fabric of the present invention, the carbon nanotube fiber yarns containing the N-doped carbon nanotubes are used as one of warp yarns and weft yarns and the any existing yarns are used as the other of warp yarns and weft yarns, and a weaving process is performed, such that warp yarns and weft yarns are interwoven to form a fabric, and the content of the N-doped carbon nanotubes in the fabric must be at least 1 wt. % based on the total weight of the fabric. In other words, the material of warp yarns is different from that of weft yarns, and the total content of the N-doped carbon nanotubes in the warp yarns or the weft yarns using the carbon nanotube fiber yarns containing the N-doped carbon nanotubes must be at least 1 wt. %. As shown in FIG. 3, the carbon nanotube fiber yarns containing the N-doped carbon nanotubes are used as the warp yarns 200 and the any existing yarns are used as the weft yarns 204, and the warp yarns 200 and the weft yarns 204 are interwoven to form the hydrophilic fabric 20, and the total content of the N-doped carbon nanotubes in the warp yarns 200 is at least 1 wt. %. Depending on the actual application, the hydrophilic fabric 20 may have various weaving densities, which is not limited in the present invention. The weft yarns 204 may be cotton fiber yarn, linen fiber yarn, wool fiber yarn, rabbit hair fiber yarn, silk fiber yarn, tencel fiber yarn, coffee fiber yarn, nylon fiber yarn, polyester fiber yarn, rayon fiber yarn, acrylic fiber yarn or polyurethane fiber yarn. In addition, in this case, the diameter of the fibers constituting the weft yarns 204 is, for example, between 10 nm and 10⁶ nm.

Since the hydrophilic fabric 20 is woven by using the carbon nanotube fiber yarns of the present invention and the any existing yarns, the hydrophilic fabric 20 may have the same characteristics as the hydrophilic fabric 10 and also have characteristics as the any existing yarns. Therefore, the hydrophilic fabric 20 may better meet the actual needs and have a wider range of applications.

The hydrophilic fabric of the present invention will be described below with experimental examples.

### Experimental Example 1

First, benzylamine (Benzylamine ReagentPlus®, 99%, Sigma-Aldrich, USA) and ferrocene (CAS No. 102-54-5, Sigma-Aldrich, USA) as a catalyst are atomized by using an atomizer, introduced into a quartz tube by a mixing gas of hydrogen (15%) and argon, and carbon nanotubes are grown on a silicon oxide substrate at 850° C., wherein the nitrogen content of each of the carbon nanotubes is 5 at. %, the diameter of the carbon nanotube is about 25 nm, and the density of the carbon nanotube is 0.26 g/cm³. Then, a drawing process is performed to obtain carbon nanotube fibers. Next, the carbon nanotube fibers are spun to form carbon nanotube fiber yarns. Afterwards, the carbon nanotube fiber yarns are weaved by a plain weave method to obtain a hydrophilic fabric, wherein the content of the N-doped carbon nanotubes in the hydrophilic fabric is 1 wt. % based on the total weight of the hydrophilic fabric.

The hydrophilic fabric was analyzed by Fourier-transform infrared spectroscopy (FTIR) and the results were: 1026 cm⁻¹, 1250 cm⁻¹, 1372 cm⁻¹, 1445 cm⁻¹, 1736 cm⁻¹, 2362 cm⁻¹, 2851 cm⁻¹, and 2925 cm⁻¹, which represent groups such as Si—O, C—N, N—CH₃, CNT, C—O, and C—Hₓ. It can be seen that the hydrophilic fabric contains N-doped carbon nanotubes, and the carbon nanotubes have hydrophilic groups (C—N, and N—CH₃).

In addition, the hydrophilic fabric is subjected to a hydrophilicity test, a contact angle of 45° can be obtained.

### Experimental Example 2

Except that the nitrogen content of each of the N-doped carbon nanotubes is 10 at. %, the hydrophilic fabric was prepared in the same way as in Experimental Example 1.

The hydrophilic fabric is subjected to a hydrophilicity test, a contact angle of 40° can be obtained.

### Experimental Example 3

Except that the nitrogen content of each of the N-doped carbon nanotubes is 1 at. %, the hydrophilic fabric was prepared in the same way as in Experimental Example 1.

The hydrophilic fabric is subjected to a hydrophilicity test, a contact angle of 50° can be obtained.

### Comparative Example 1

Except that the nitrogen doping was not performed when growing the carbon nanotubes, the hydrophilic fabric was prepared in the same way as in Experimental Example 1.

The hydrophilic fabric is subjected to a hydrophilicity test, a contact angle of 140° can be obtained.

From Experimental Example 1, Experimental Example 2, Experimental Example 3 and Comparative Example 1, it can be seen that a fabric made of carbon nanotube fibers containing N-doped carbon nanotubes, and the content of N-doped carbon nanotubes in the fabric is at least 1 wt. % based on the total weight of the fabric, so that the fabric may have excellent hydrophilicity, and have good mechanical strength, stain resistance and ductility depending on the characteristics of the carbon nanotubes at the same time.

It will be apparent to those skilled in the art that various modifications and variations may be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hydrophilic fabric, having a structure in which warp yarns and weft yarns are interwoven with each other, wherein at least one of the warp yarns and the weft yarns comprises carbon nanotube fibers, the carbon nanotube fibers contain nitrogen-doped (N-doped) carbon nanotubes, the nitrogen content of each of the N-doped carbon nanotubes is between 1 at. % and 10 at. %, and the content of the N-doped carbon nanotubes in the hydrophilic fabric is at least 1 wt. % based on the total weight of the hydrophilic fabric.

2. The hydrophilic fabric of claim 1, wherein the carbon nanotube fibers contain natural fiber material.

3. The hydrophilic fabric of claim 2, wherein the natural fiber material comprises cotton, linen, wool, rabbit hair, silk, tencel or coffee.

4. The hydrophilic fabric of claim 1, wherein the diameter of the carbon nanotube fibers is between 10 nm and 100 nm.

5. The hydrophilic fabric of claim 1, wherein the density of the carbon nanotube fibers is between 0.5 g/cm³ and 1.8 g/cm³.

6. The hydrophilic fabric of claim 1, wherein the material of the weft yarns is the same as the material of the warp yarns.

7. The hydrophilic fabric of claim 1, wherein the material of the weft yarns is different from the material of the warp yarns.

8. The hydrophilic fabric of claim 7, wherein one of the warp yarns and the weft yarns comprises carbon nanotube fibers, and the other of the warp yarns and the weft yarns comprises cotton fiber yarn, linen fiber yarn, wool fiber yarn, rabbit hair fiber yarn, silk fiber yarn, tencel fiber yarn, coffee fiber yarn, nylon fiber yarn, polyester fiber yarn, rayon fiber yarn, acrylic fiber yarn or polyurethane fiber yarn.

9. The hydrophilic fabric of claim 8, wherein the diameter of the fiber constituting the other of the warp yarns and the weft yarns is between 10 nm and 10⁶ nm.

10. The hydrophilic fabric of claim 1, wherein the contact angle of the hydrophilic fabric is between 40° and 70°.

11. A manufacturing method of a hydrophilic fabric, comprising:
growing nitrogen-doped (N-doped) carbon nanotubes on a substrate, wherein the nitrogen content of each of the N-doped carbon nanotubes is between 1 at. % and 10 at. %;
performing a drawing process to draw the N-doped carbon nanotubes to form carbon nanotube fibers;
performing a spinning process to spin the carbon nanotube fibers to form carbon nanotube fiber yarns; and
performing a weaving process to weave the carbon nanotube fiber yarns,
wherein the content of the N-doped carbon nanotubes in the hydrophilic fabric is at least 1 wt. % based on the total weight of the hydrophilic fabric.

12. The manufacturing method of claim 11, further comprising:
mixing the carbon nanotubes with natural fiber material after forming the carbon nanotubes but before the drawing process.

13. The manufacturing method of claim 12, wherein the natural fiber material comprises cotton, linen, wool, rabbit hair, silk, tencel or coffee.

14. The manufacturing method of claim 11, wherein the diameter of the carbon nanotube fibers is between 10 nm and 100 nm.

15. The manufacturing method of claim 11, wherein the density of the carbon nanotube fibers is between 0.5 g/cm³ and 1.8 g/cm³.

16. The manufacturing method of claim 11, wherein the carbon nanotube fiber yarns are used as one of the warp yarns and the weft yarns, and the material of the weft yarns is different from the material of the warp yarns during the weaving process.

17. The manufacturing method of claim 16, wherein one of the warp yarns and the weft yarns comprises carbon nanotube fibers, and the other of the warp yarns and the weft yarns comprises cotton fiber yarn, linen fiber yarn, wool fiber yarn, rabbit hair fiber yarn, silk fiber yarn, tencel fiber yarn, coffee fiber yarn, nylon fiber yarn, polyester fiber yarn, rayon fiber yarn, acrylic fiber yarn or polyurethane fiber yarn.

18. The manufacturing method of claim 17, wherein the diameter of the fiber constituting the other of the warp yarns and the weft yarns is between 10 nm and 10⁶ nm.

19. The manufacturing method of claim 11, wherein the material of the weft yarns is the same as the material of the warp yarns.

20. The manufacturing method of claim 11, wherein the contact angle of the hydrophilic fabric is between 40° and 70°.
